(19) United States
(12) Patent Application Publication
(10) Pub. No.: US 2014/0340587 A1
(43) Pub. Date: Nov. 20, 2014

(54) DISPLAY DEVICE AND TELEVISION RECEIVER

(71) Applicant: SHARP KABUSHIKI KAISHA, Osaka-shi, Osaka (JP)

(72) Inventor: Kohki Ejiri, Osaka-shi (JP)

(21) Appl. No.: 14/375,647

(22) PCT Filed: Jan. 29, 2013
(86) PCT No.: PCT/JP2013/051817

§ 371 Date: Jul. 30, 2014

(30) Foreign Application Priority Data
Jan. 31, 2012 (JP) 2012-018285

(51) Int. Cl. H04N 5/645

(52) U.S. Cl. CPC H04N 5/645
USPC 348/794; 361/679.21

(57) ABSTRACT

Provided is a display device in which a wire material can be held to a front cabinet with favorable workability and low cost, and a wire material is desirably suppressed from being caught at a boss or the like when a rear cabinet is screwed to the front cabinet, and a television receiver with the display device.

A boss is provided on a substrate attachment part which protrudes obliquely at a lower side of a frame part of a front cabinet. The boss includes a pedestal having a vertical cross section formed into a substantially C-shape, a tubular boss body provided on a flat surface of the pedestal, and a locking part continuously formed from the flat surface of the pedestal. The locking part includes a first stopper protruding in a surface direction of the substrate attachment part, and a second stopper which is provided at a tip of the first stopper so as to face the substrate attachment part. A wire harness is held by the locking part.

### CROSS-REFERENCE TO RELATED APPLICATIONS

This application is the national phase under 35 U.S.C. §371 of PCT International Application No. PCT/JP2013/51817 which has an International filing date of Jan. 29, 2013 and designated the United States of America.

### BACKGROUND

1. Technical Field

The present invention relates to a display device having, inside a front cabinet thereof, a wiring shaping structure for holding a wiring of a speaker or a substrate, for example, and a television receiver having the display device.

2. Description of Related Art

A television receiver, such as a liquid crystal television receiver, for example, includes a display module having a display panel that displays an image at a front surface and a back light unit, a rectangular frame-shaped front cabinet positioned at a front side of the display module, and a rear cabinet positioned at a rear side of the display module. The rear cabinet is screwed to a boss part provided on a rear surface of the front cabinet. The back light unit is placed at a rear side of the display panel and accommodates an optical sheet, a light guide plate, and an LED substrate in a chassis.

Generally, at a long side portion of a lower side of the rear surface of the front cabinet, speakers, and small substrates, such as a substrate for light emitting diode, a WiFi substrate, a substrate for receiving a light from a remote controller, are attached. Then, a main substrate on which a tuner and a CPU (Central Processing Unit) or the like are mounted is provided on a rear surface of the chassis. The speakers, the small substrates, and the main substrate are connected by a wire harness (wire material).

In order to hold (shape the wiring) the wire harness inside the front cabinet, hooks and ribs may be provided as many as possible on the long side portion of the front cabinet, or WHs (wire holders) and tape are directly attached to the portions where hooks and ribs cannot be provided, thereby fixing the wire harness. This prevents a wire from being caught by a boss or the like (damage of the wire harness), due to a movement of the wire harness at the time of screwing the front cabinet to the rear cabinet.

Japanese Patent Application Laid-Open No. 2010-238776 discloses a display device wherein, in a plate-like rib provided on a front cabinet, a fitting-in groove which is recessed to a base end side from a top surface of the rib, and in which a conductive wire is fitted is provided, and on an internal surface of the fitting-in groove, a groove in the recessed direction of the fitting-in groove is provided to mold the rib so that mold-matching surfaces of a split-mold and an insert die are positioned at the groove, thereby generating a pointed edge and a burr, which are formed on the mold-matching surfaces of the split-mold and the insert die, in the groove. The display device prevents a conductive wire from being damaged by a rib.

### SUMMARY

There is a problem that newly providing a hook and rib, such as the one described in Japanese Patent Application Laid-Open No. 2010-238776, for wiring shaping, is difficult because of the following reasons: forming a hole on the long side portion is not preferable considering the product design; forming a wiring shaping part, such as a hook and a rib, is difficult because the width in the height direction of the long side portion is narrow; a undesirable appearance, such as a sink, is likely generated on the surface of the product when a wiring shaping part is added; and adding a tilting core is difficult due to the structure of the mold.

As a result, WHs and tape are attached to several portions for fixing a wire harness. However, this makes the work complicated and also increases the cost for the operation and the cost for parts.

The present invention is made in view of the above circumstances. An object of the present invention is to provide a display device in which a wire material can be held to a front cabinet at low cost with a high degree of workability, and the wire material can be satisfactorily suppressed from being caught at a boss or a similar element when a rear cabinet is screwed onto the front cabinet for assembling, and a television receiver that has the display device.

A display device according to the present invention is characterized by comprising: a display panel which displays an image at a front surface of the display panel; a frame-shaped front cabinet placed at a front side of the display panel; a rear cabinet placed at a rear side of the display panel; a boss provided on a rear surface of the front cabinet for screwing the rear cabinet; and a wire material positioned on the rear surface of the front cabinet, wherein the boss has a locking part which locks the wire material, and the locking part comprises a first stopper which protrudes in a surface direction of the rear surface of the front cabinet and suppresses a movement of the wire material in a posterior-anterior direction. The display device according to the present invention is characterized in that the locking part comprises a second stopper which is provided at a tip of the first stopper so as to face the rear surface of the front cabinet, and suppresses a movement of the wire material in the surface direction.

In the present invention, a wire material can easily be retained by holding the wire material at a locking part. Compared to a case where a wire material is fixed by attaching a WH and tape, workability is favorable and the cost for the operation and the cost for the parts are reduced. Also, as the locking part that holds the wire material is provided on a boss, when a rear cabinet is screwed to a front cabinet, it is possible to favorably prevent the wire material from being caught at a boss or the like while the movement of the wire material is suppressed.

Moreover, investment cost for a mold can be reduced by molding the locking part without adding a tilting core.

Also, a movement of the wire material in a surface direction and a posterior-anterior direction of the front cabinet is favorably suppressed.

The display device according to the present invention is characterized in that an outer surface of the second stopper is inclined toward the rear surface of the front cabinet.

In the present invention, it is easy to insert a wire material.

The display device according to the present invention is characterized by further comprising a rib which extends in a protruding direction of the first stopper, on an outer surface of the first stopper.

In the present invention, deflection strength is high and a wire material hardly comes off.

The display device according to the present invention is characterized by that the boss has a pedestal, and the first stopper is provided on the pedestal.

In the present invention, it is possible to desirably suppress a movement of the wire material near the rear of the front cabinet, thereby further suppressing that the wire material is caught at the boss.

The display device according to the present invention characterized by that the pedestal is hollow and has an opening at a part of a side surface, the first stopper is provided on a portion adjacent to the opening of the pedestal in the surface direction, and a side surface inside the first stopper of the pedestal is also opened.

In the present invention, it is possible to mold the locking part without adding a tilting core. Thus, unlike a case where a wiring shaping part is newly added, an undesirable appearance, such as a sink, is not generated on the surface of the display device.

A television receiver according to the present invention characterized by comprising the display device and a receiving part which receives a television broadcast, wherein an image is displayed on the display device based on the television broadcast received at the receiving part.

In the present invention, workability in assembly is favorable and the cost thereof is reduced.

According to the display device of the present invention, a wire material can easily be retained by holding the wire material at a locking part. Compared to a case where a wire material is fixed by attaching WHs and tape, workability is preferable and the cost for the operation and the cost for the parts are reduced. Also, as the locking part that holds the wire material is provided on a boss, when a rear cabinet is screwed to a front cabinet, it is possible to suppress a movement of the wire material, whereby the wire material is favorably prevented from being caught at a boss or the like. Moreover, investment cost for a mold can be reduced by molding the locking part without adding a tilting core.

The above and further objects and features will more fully be apparent from the following detailed description with accompanying drawings.

### BRIEF DESCRIPTION OF THE SEVERAL VIEWS OF THE DRAWINGS

FIG. 1 is a perspective view schematically illustrating a television receiver according to an embodiment of the present invention;

FIG. 2 is a rear view illustrating the television receiver according to the embodiment of the present invention;

FIG. 3 is a cross sectional view illustrating a cross section taken from in FIG. 2;

FIG. 4 is a partially enlarged view of FIG. 3;

FIG. 5 is a front view illustrating a front cabinet according to the embodiment of the present invention;

FIG. 6 is a rear view illustrating the front cabinet according to the embodiment of the present invention;

FIG. 7 is a rear view illustrating a rear cabinet according to the embodiment of the present invention;

FIG. 8 is an enlarged plan view illustrating a boss according to the embodiment of the present invention;

FIG. 9 is an enlarged perspective view illustrating the boss according to the embodiment of the present invention;

FIG. 10 is an enlarged side view illustrating the boss according to the embodiment of the present invention;

FIG. 11A is a schematic perspective view illustrating a state where a tilting core is used at the time of molding the boss according to the embodiment of the present invention, with a split mold already opened;

FIG. 11B is a schematic perspective view illustrating a state where a tilting core is used at the time of molding the boss according to the embodiment of the present invention, with the tilting core pulled out;

FIG. 12 is a perspective view illustrating a state where a speaker, a substrate, and a switch are attached to a substrate attachment part of the front cabinet according the embodiment of the present invention;

FIG. 13 is an enlarged perspective view illustrating a state where a wire harness is held by a locking part of the boss according to the embodiment of the present invention;

FIG. 14 is an enlarged side view illustrating a state where the wire harness is held by a locking part of the boss according to the embodiment of the present invention; and

FIG. 15 is a side view illustrating another boss.

### DETAILED DESCRIPTION

The present invention is described below with reference to the drawings illustrating an embodiment thereof.

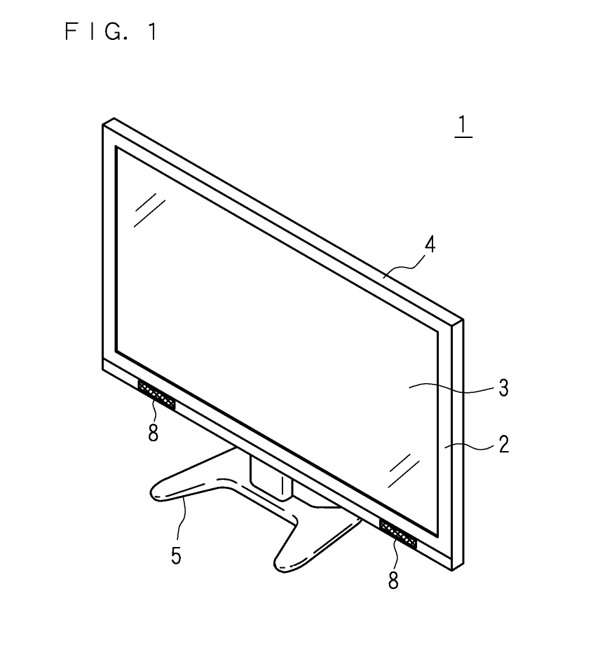

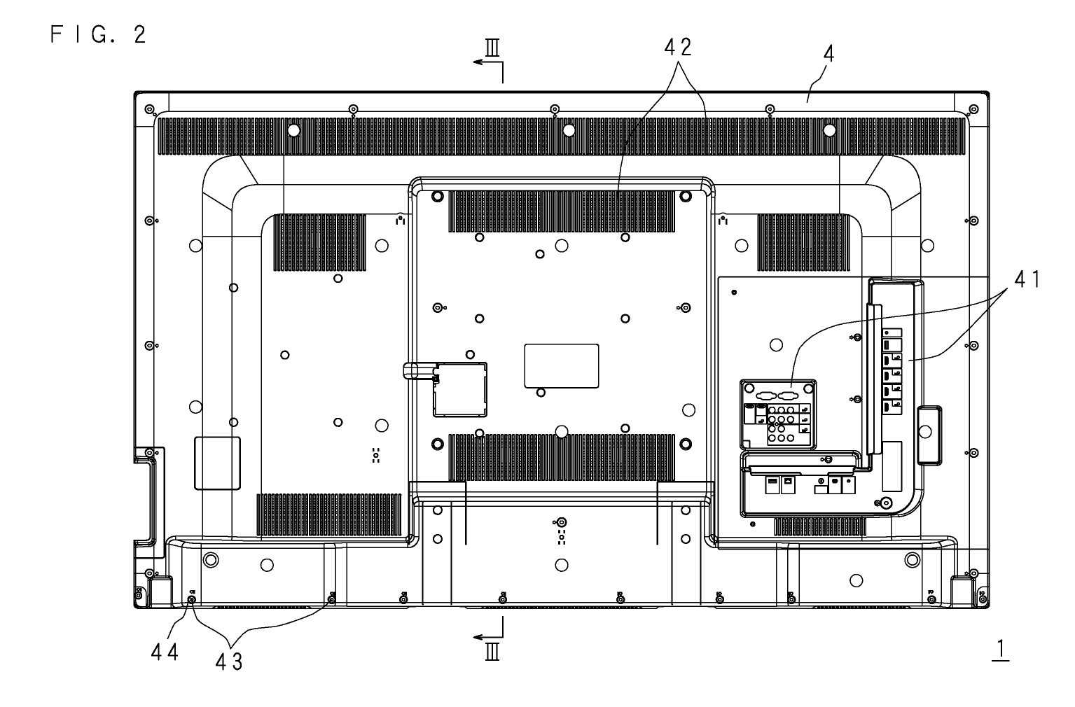

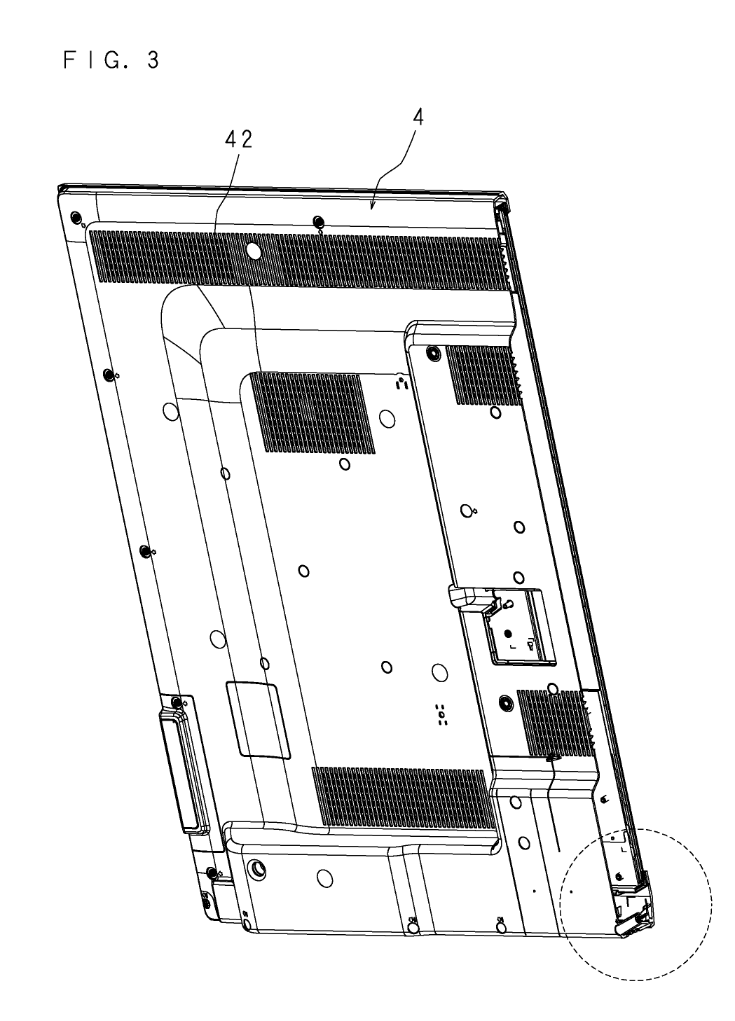

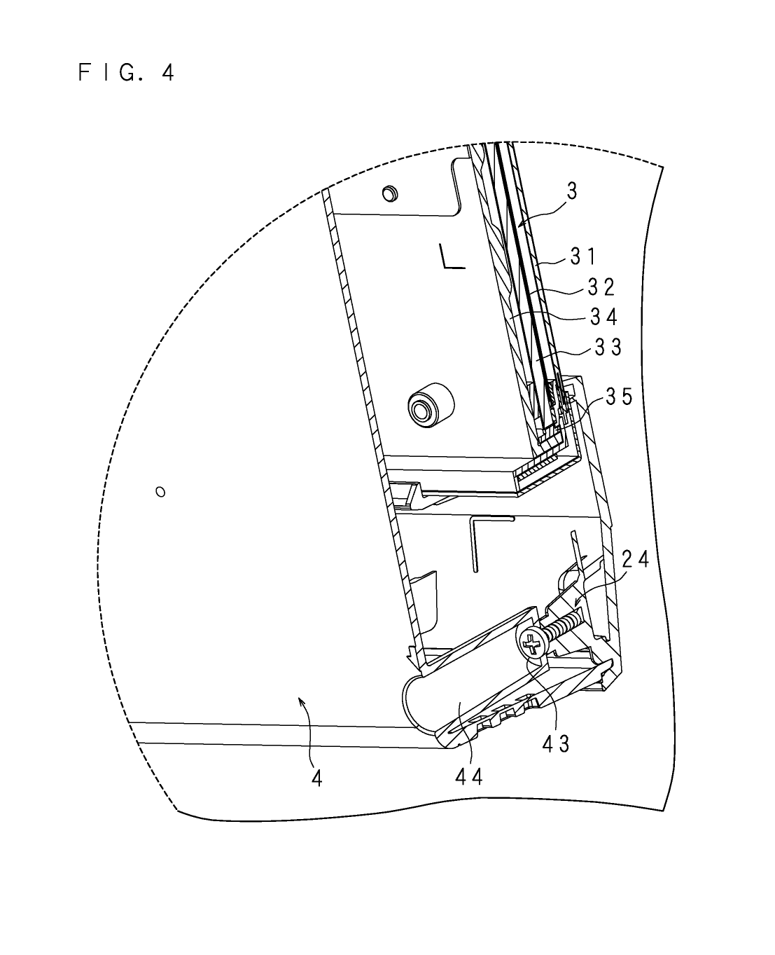

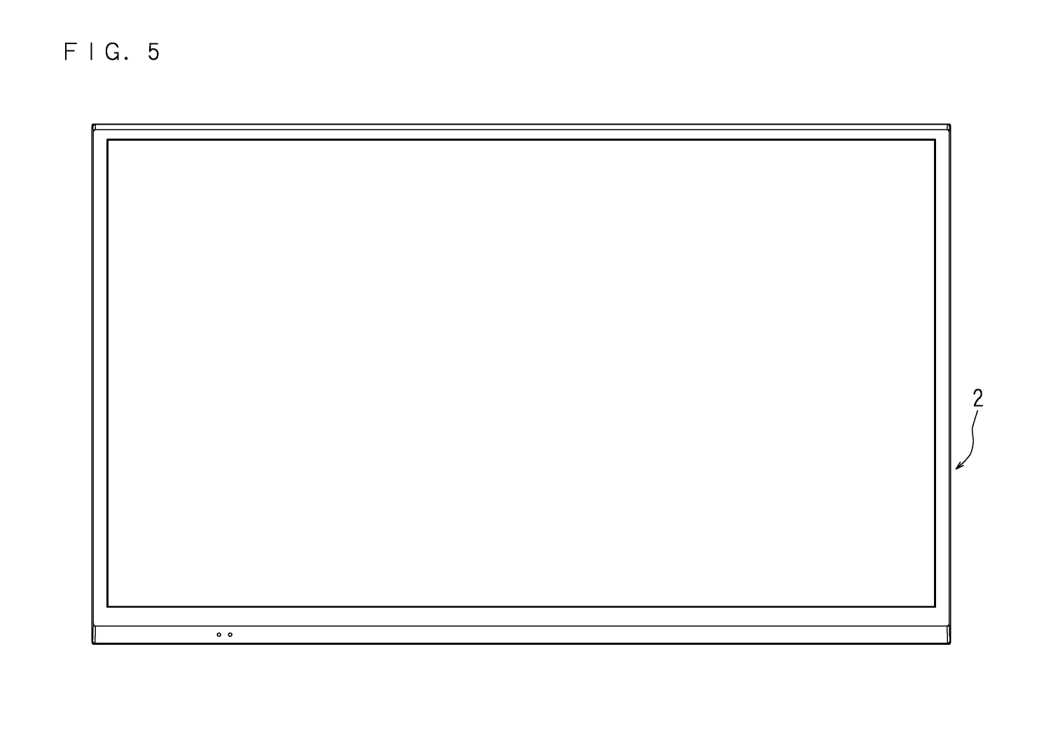

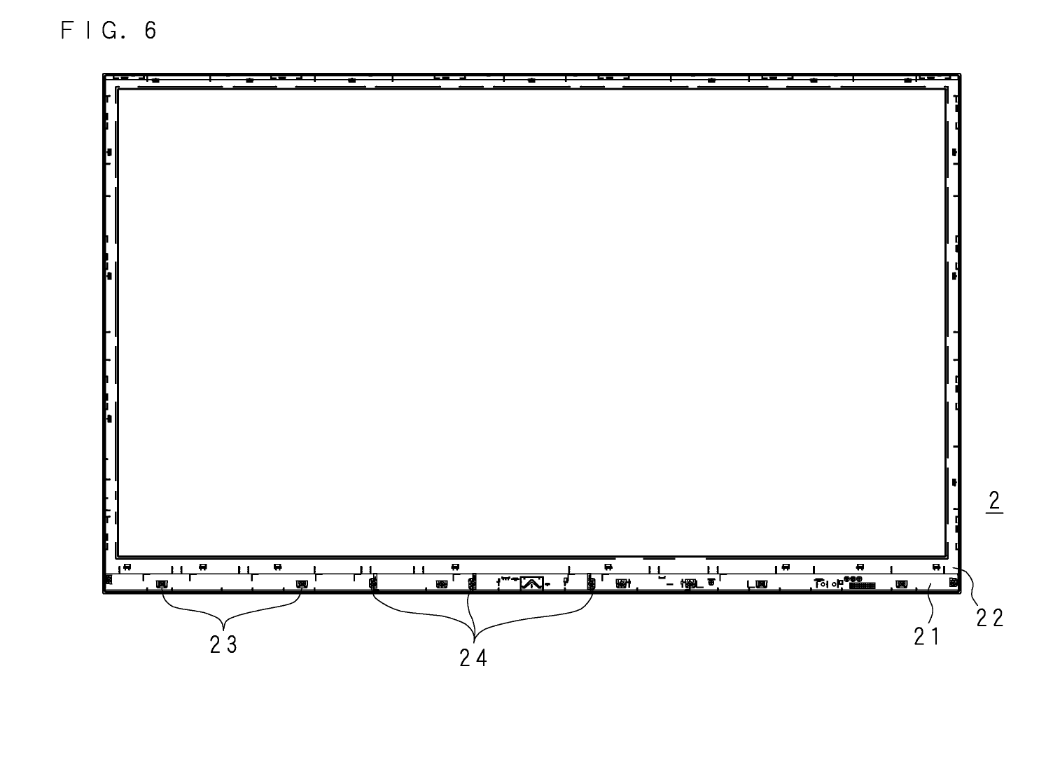

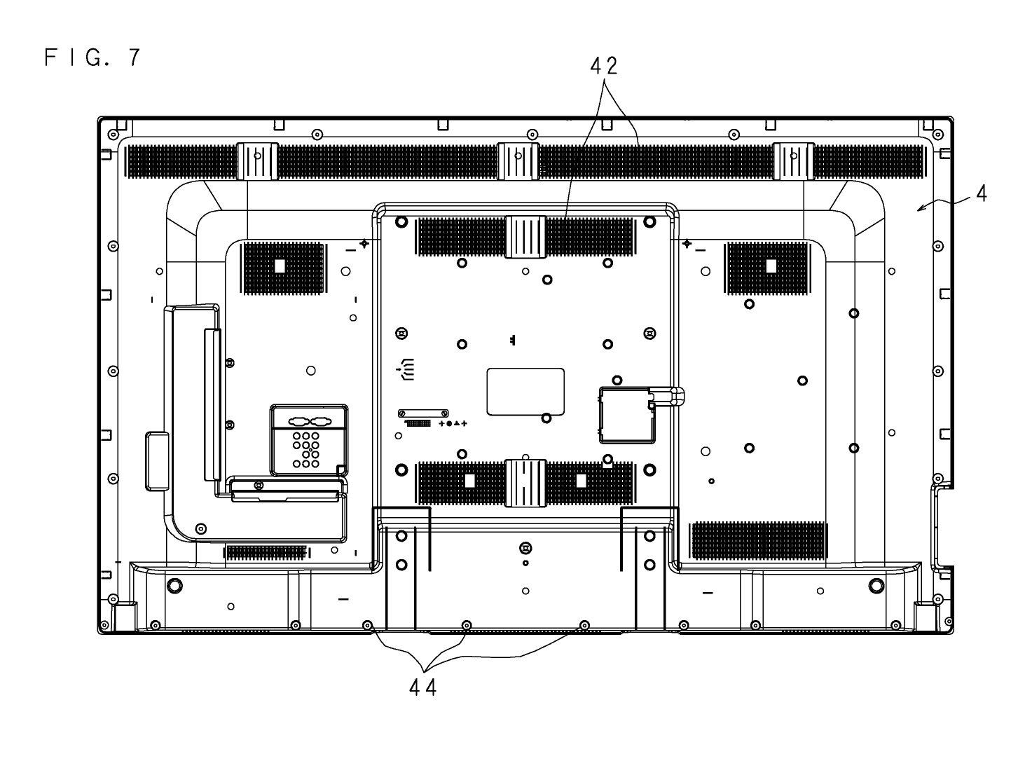

FIG. 1 is a perspective view schematically illustrating a television receiver 1 (hereinafter, referred to as TV receiver) according to the present invention, FIG. 2 is a rear view illustrating the TV receiver 1, FIG. 3 is a cross sectional view illustrating a cross section taken from III-III in FIG. 2, FIG. 4 is a partially enlarged view of FIG. 3, FIG. 5 is a front view illustrating a front cabinet 2, FIG. 6 is a rear view illustrating the front cabinet 2, and FIG. 7 is a rear view illustrating a rear cabinet 3. In FIGS. 5 and 6, substrates and a wire harness are not illustrated.

The TV receiver 1 has a display module 3 that includes a display panel and a back light unit, a front cabinet 2 and a rear cabinet 4 which are made of synthetic resin and accommodate the display module 3 in a sandwiched manner, a stand 5, and two speakers 8 provided at a lower part of the front side of the display module 1. The display module 3 as a whole is formed in the shape of a horizontally long and substantially rectangular parallelepiped and accommodated between the front cabinet 2 and the rear cabinet 4 in an upright state.

The front cabinet 2 includes a frame part 22 which is formed into a rectangular frame-shape and covers an outer edge of the display module 3, and a substrate attachment part 21 which is provided at a long side of a lower part of the frame part 22 so as to obliquely protrude backward of the TV receiver 1 and to which the substrates are attached.

At the substrate attachment part 21, a plurality of bosses 23 and bosses 24 for screwing the rear cabinet 4 are provided. The bosses 23 are provided on an end part side in a longitudinal direction of the substrate attachment part 21 and the bosses 24 are provided at a central part side in a longitudinal direction of the substrate attachment part 21. As described later, the boss 24 has a locking part 245 that holds a wire harness (wire material) 7.

The rear cabinet 4 is formed into a box-shape for covering a side face and a rear face of the display module 3. As shown in the right side of FIG. 2, the rear cabinet 4 has two terminal panels 41 being provided with an input terminal, an output terminal, an antenna input terminal, a USB terminal, a headphone terminal, and a B-CAS card insertion slot, as well as a plurality of heat-radiating slits 42.

Then, a plurality of screw insertion holes 44 are formed at a circumferential part, and the screws 43 are inserted into the screw insertion holes 44 to be screwed to the bosses 23 and 24.

As illustrated in FIG. 4, the display module 3 includes a liquid crystal display panel 31, an optical sheet 32, a light guide plate 33, a chassis 34, and an LED substrate 35. A back light unit is configured with the optical sheet 32, the light guide plate 33, the chassis 34 and the LED substrate 35. When a display operation is performed, a planar light is emitted from the light guide plate 33, by which a rear face of the liquid crystal display panel 31 is illuminated.

The liquid crystal display panel 31 has a liquid crystal layer, a pair of glass substrates, and a pair of polarizing plates. The pair of glass substrates are laminated with each other with a sealing material therebetween, and the liquid crystal layer is held between the pair of glass substrates. The polarizing plates are placed on faces opposite to the liquid crystal layer side of each of the pair of glass substrates.

The chassis 34 is formed into a substantially box shape in which the liquid crystal display panel 31 side is opened. Then, the optical sheet 32, the light guide plate 33, and the LED substrate 35 are accommodated in the chassis 34.

On a rear face of the chassis 34, a main substrate having a tuner and a CPU or the like is provided (not illustrated).

The light guide plate 33 is formed into a rectangular plate-shape and has a main surface facing the liquid crystal display panel 31 side, a rear surface which is opposite to the main surface and faces the chassis 34, a pair of long side surfaces, and a pair of short side surfaces. One of the long side surfaces serves as a light incident surface for guiding a light into the light guide plate 33, and the light guided into the light guide plate 33 from the long side surface is emitted from the main surface of the light guide plate 33 toward the liquid crystal display panel 31 side.

The optical sheet 32 is a sheet group including a diffusion sheet, a lens sheet and a DBEF sheet (reflective polarizing sheet), or the like, and mounted on the main surface of the light guide plate 33. With this optical sheet 32, diffusing and condensing the light emitted from the main surface of the light guide plate 33 are performed.

The LED substrate 35 is for generating a light to be guided into the light guide plate 33 and placed at the long side surface of the light guide plate 33. A plurality of LEDs are mounted on a flat surface of the main body of the LED substrate 35. The LED substrate 35 extends along the long side of the main surface of the light guide plate 33 in such a manner that the plurality of LEDs face the long side surface of the light guide plate 33.

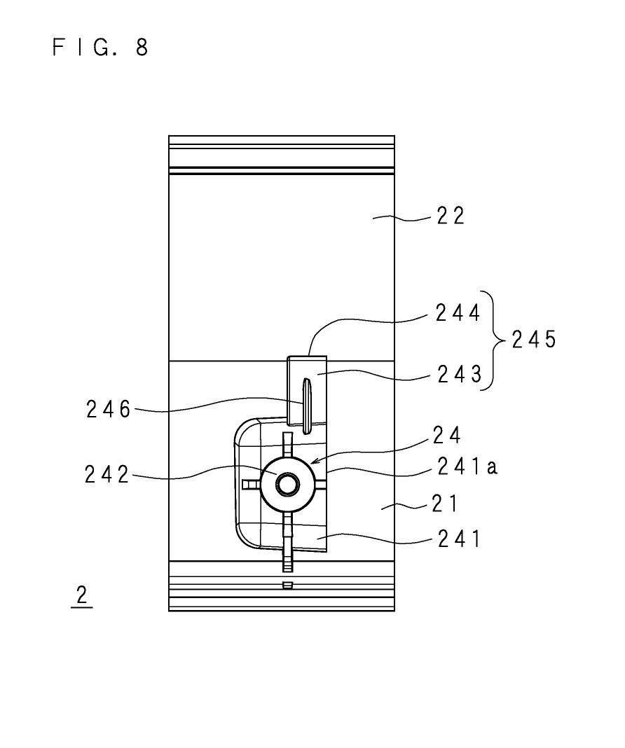

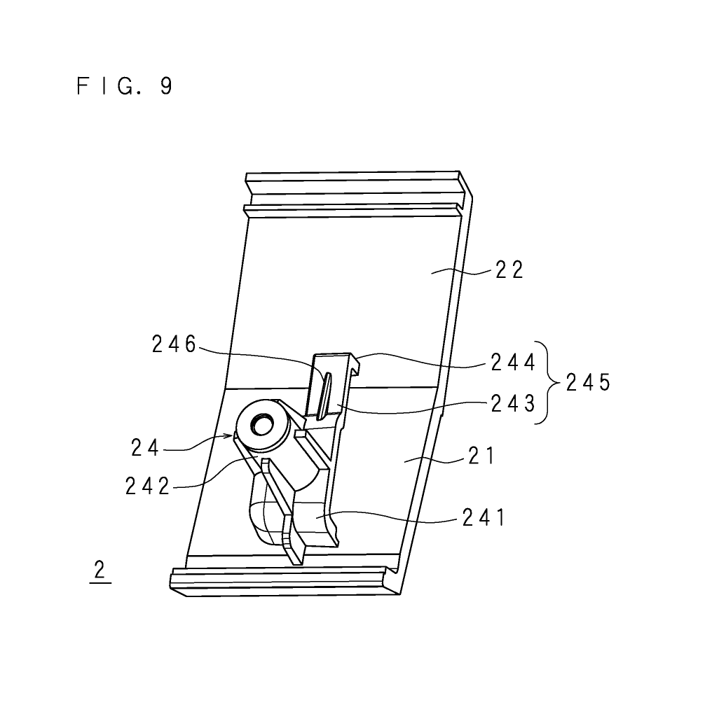

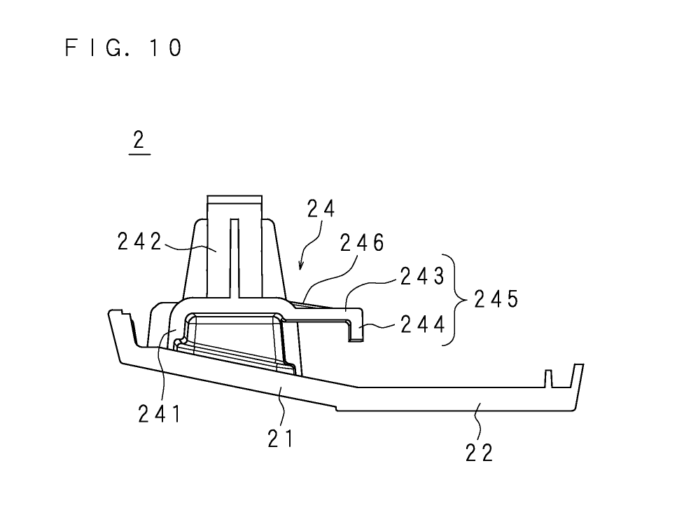

FIG. 8 is an enlarged plan view illustrating the boss 24, FIG. 9 is an enlarged perspective view illustrating the boss 24, and FIG. 10 is an enlarged side view illustrating the boss 24.

The boss 24 has a pedestal 241 with a rectangular shape in a plan view, a tubular boss body 242 provided on a flat surface of the pedestal 241, and a locking part 245 provided continuously from the flat surface of the pedestal 241.

A female screw is provided at an inner surface of the boss body 242, and a screw 43 inserted into the screw insertion hole 44 of the rear cabinet 4 is screwed to the female screw of the boss body 242.

The locking part 245 has a first stopper 243 protruding in a surface direction of the substrate attachment part 21, and a second stopper 244 provided at a tip of the first stopper 243 so as to face the substrate attachment part 21. The locking part 245 as a whole has a substantially L-shape when viewed from a side.

The pedestal 241 is hollow, and has an opening 241a at a part of a side surface (the right side in FIG. 8). The first stopper 243 is provided at a portion adjacent to the opening 241a of the pedestal 241 in the surface direction. An inner side surface of the first stopper 243 of the pedestal 241 is also opened.

The pedestal 241 has a high strength because it has a side wall portion with a vertical cross section formed into a substantially C-shape, apart from the opening 241a and the opening of the inside of the first stopper 243.

Moreover, as a rib 246 is placed on an outer surface of the first stopper 243, deflection strength is high.

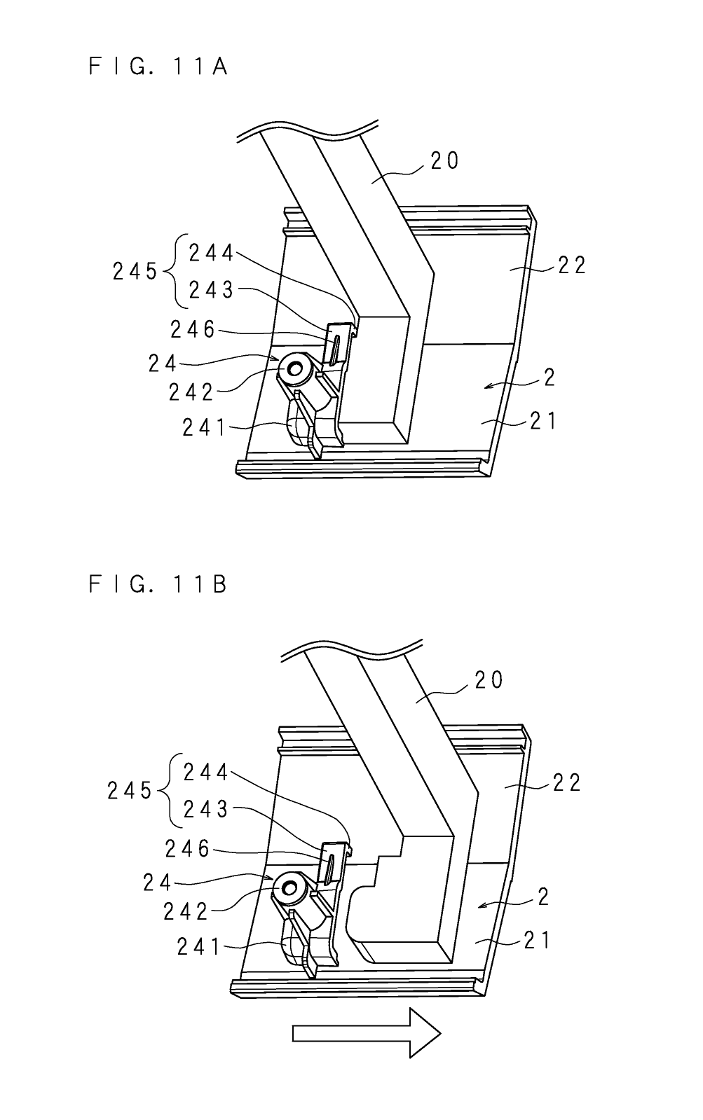

FIGS. 11A and 11B each illustrate a schematic perspective view of a state where a tilting core 20 is used when the boss 24 is molded. Split-molds which correspond to the front side and the rear side of the front cabinet 2 are not illustrated.

Conventionally, a pedestal is made to be hollow in order to avoid generation of a sink and an increase in weight, and the pedestal is molded with a tilting core which slides in a longitudinal direction of the substrate attachment part 21. In the present embodiment, the locking part 245 is also molded with the tilting core 20 that molds the pedestal 241. The tilting core 20 that is tilted has a shape which matches a shape of the inner surface side (hollow portion) of the boss 24. In order to form the hollow portion, the tilting core 20 is used when the front cabinet 2 is molded. FIG. 11A illustrates a state after the split-mold is opened, and FIG. 11B illustrates a state in which the tilting core 20 is pulled out.

As configured in the above-mentioned manner, it is possible to mold the locking part 245 without adding the tilting core 20 in the present embodiment. Thus, unlike a case where a wiring shaping part is newly added, a bad appearance, such as a sink, is not generated on the surface of the display device.

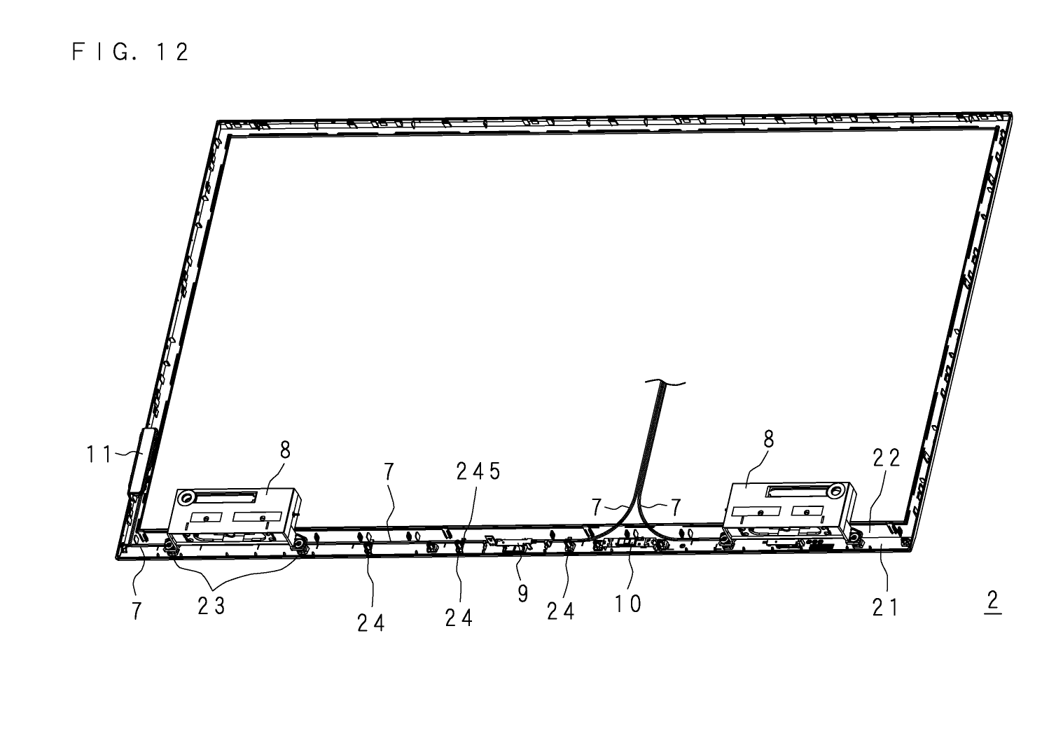

FIG. 12 is a perspective view illustrating a state where a speaker 8, substrates 9, 10, and a switch 11 are attached to the substrate attachment part 21 of the front cabinet 2.

At each of the both end sides of the substrate attachment part 21, the speaker 8 is attached between two bosses 23 of the end sides. In FIG. 12, the substrate 9 and the substrate 10 are placed at the center of the substrate attachment part gland at a slightly right side from the center of the substrate attachment part 21, respectively. The switch 11 is placed at a lower end part of a short side at the left side in FIG. 12.

Between the switch 11 and the speaker 8 at the left side and between the speaker 8 and the substrate 9 are connected with a wire harness 7. The wire harness 7 extending from the right side of the substrate 9 is brought together with a wire harness 7 extending from the speaker 8 at the right side, and connected to the main substrate positioned on the chassis 34. As illustrated in FIG. 12, the wire harness 7 is held by the locking part 245 of the boss 24.

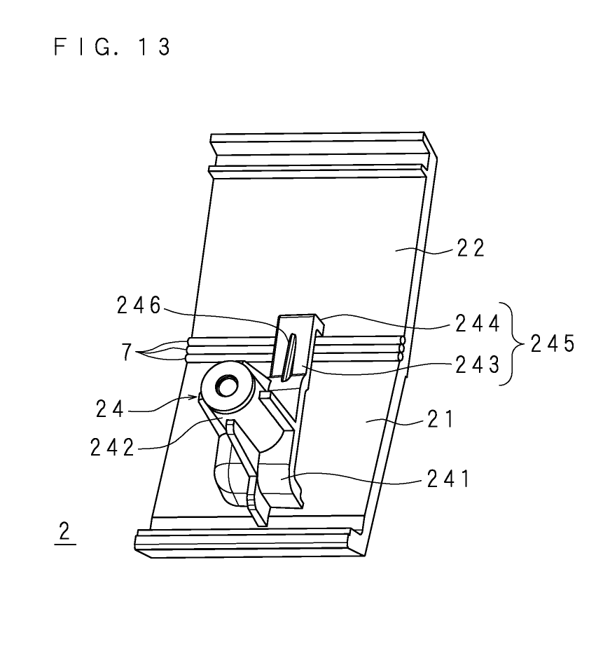

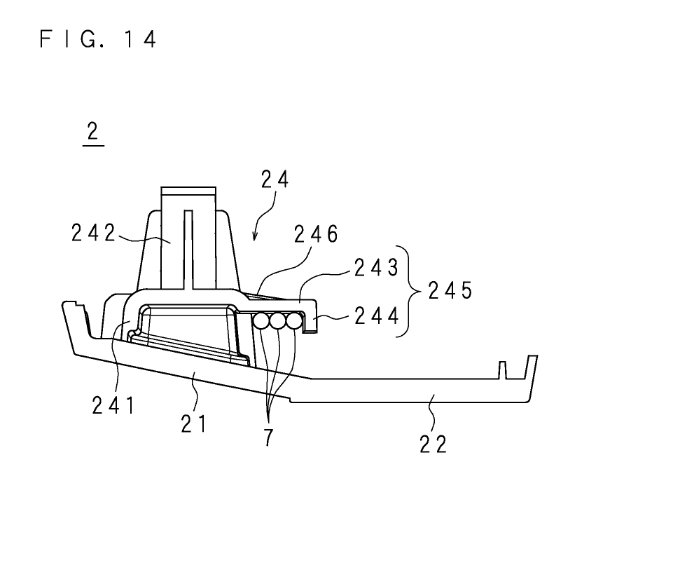

FIG. 13 is an enlarged perspective view illustrating a state where the wire harness 7 is held by the locking part 245 of the boss 24, FIG. 14 is an enlarged side view illustrating a state where the wire harness 7 is held by the locking part 245 of the boss 24.

When assembling the TV receiver 1, an operator inserts the wire harness 7 from the lower side of the locking part 245 and holds the wire harness 7 at the second stopper 244. Compared to a case where the wire harness 7 is fixed by attaching WHs and tape, workability is better and the costs for operation and the cost for parts can also be reduced.

Since the locking part 245 is configured as described above, the movement of the wire harness 7 in a back and forth direction of the TV receiver 1 is suppressed by the first stopper 243, and the movement of the wire harness 7 in the surface direction of the front cabinet 2 is suppressed. Once the wire harness 7 is held by the locking part 245, the wire harness 7 is prevented from coming off unless the wire harness 7 is taken out by bending the first stopper 243 manually. The first stopper 243 is hardly bent as a rib 246 is provided.

As described-above, the wire harness 7 is held at the locking part 245 of the boss 24. In the present embodiment, when assembling the TV receiver 1, for example, when screwing the rear cabinet 4 to the front cabinet 2, it is possible to prevent the wire harness 7 from being caught at the boss 24 or the like while the movement of the wire harness 7 is suppressed.

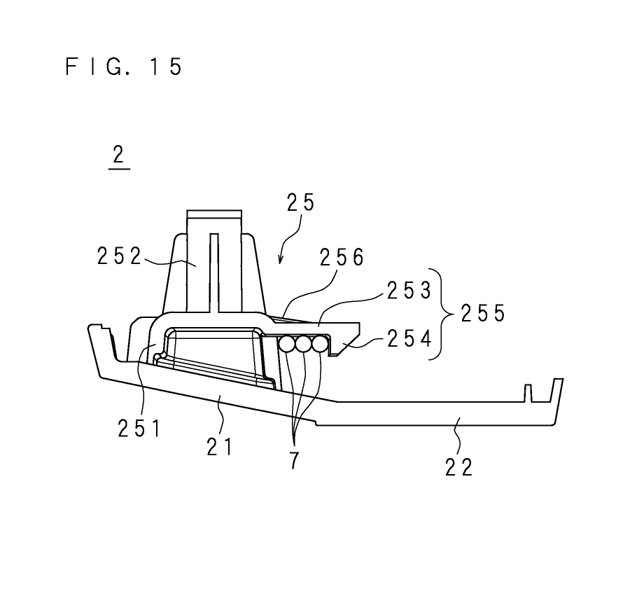

FIG. 15 is a side view illustrating another boss 25. In FIG. 15, same reference numerals are assigned to the portions which are the same in FIG. 14, and no detailed description thereof is provided.

The boss 25 has a pedestal 251 with a rectangular shape in a plan view, a tubular boss body 252 provided on a flat surface of the pedestal 251, and a locking part 255 provided continuously from the flat surface of the pedestal 251.

The locking part 255 has a first stopper 253 protruding in a surface direction of the substrate attachment part 21, and a second stopper 254 provided at a tip of the first stopper 253 so as to face the substrate attachment part 21.

As illustrated in FIG. 15, the second stopper 254 is inclined inward toward the rear surface (inner surface) of the front cabinet 2. Accordingly, it is easy to guide the wire harness 7 to the inner surface side of the first stopper 253, thereby providing good workability.

The shapes, the positional arrangement on the front cabinet 2, and the numbers of the bosses 24, 25 are not restricted to the cases as described in the embodiment.

It should be understood that the embodiments described above are only illustrative but not limitative. The scope of the present invention is defined in the claims and includes all changes that fall within metes and bounds of the claims or equivalence of such metes and bounds thereof, but not limited to the above description.

1.-6. (canceled)

7. A display device comprising: a display panel which displays an image at a front surface of the display panel; a frame-shaped front cabinet placed at a front side of the display panel; a rear cabinet placed at a rear side of the display panel; a boss provided on a rear surface of the front cabinet for screwing the rear cabinet; and a wire material positioned on the rear surface of the front cabinet, wherein
the boss has a locking part which locks the wire material, and the locking part comprises a first stopper which protrudes in a surface direction of the rear surface of the front cabinet and suppresses a movement of the wire material in a posterior-anterior direction.

8. The display device according to claim 7, wherein the locking part comprises a second stopper which is provided at a tip of the first stopper so as to face the rear surface of the front cabinet, and suppresses a movement of the wire material in the surface direction.

9. The display device according to claim 8, wherein an outer surface of the second stopper is inclined toward the rear surface of the front cabinet.

10. The display device according to claim 7, further comprising a rib which extends in a protruding direction of the first stopper, on an outer surface of the first stopper.

11. The display device according to claim 7, wherein
the boss has a pedestal, and
the first stopper is provided on the pedestal.

12. The display device according to claim 8, wherein
the boss has a pedestal, and
the first stopper is provided on the pedestal.

13. The display device according to claim 9, wherein
the boss has a pedestal, and
the first stopper is provided on the pedestal.

14. The display device according to claim 10, wherein
the boss has a pedestal, and
the first stopper is provided on the pedestal.

15. The display device according to claim 11, wherein
the pedestal is hollow and has an opening at a part of a side surface,
the first stopper is provided on a portion adjacent to the opening of the pedestal in the surface direction, and
a side surface inside the first stopper of the pedestal is also opened.

16. The display device according to claim 12, wherein
the pedestal is hollow and has an opening at a part of a side surface,
the first stopper is provided on a portion adjacent to the opening of the pedestal in the surface direction, and
a side surface inside the first stopper of the pedestal is also opened.

17. The display device according to claim 13, wherein
the pedestal is hollow and has an opening at a part of a side surface,
the first stopper is provided on a portion adjacent to the opening of the pedestal in the surface direction, and
a side surface inside the first stopper of the pedestal is also opened.

18. The display device according to claim 14, wherein
the pedestal is hollow and has an opening at a part of a side surface,
the first stopper is provided on a portion adjacent to the opening of the pedestal in the surface direction, and
a side surface inside the first stopper of the pedestal is also opened.

19. A television receiver comprising:
the display device according to claim 7; and
a receiving part which receives a television broadcast,
wherein
an image is displayed on the display device based on the television broadcast received at the receiving part.

20. A television receiver comprising:
the display device according to claim 8; and
a receiving part which receives a television broadcast,
wherein
an image is displayed on the display device based on the television broadcast received at the receiving part.

21. A television receiver comprising:
the display device according to claim 9; and
a receiving part which receives a television broadcast,
wherein
an image is displayed on the display device based on the television broadcast received at the receiving part.

22. A television receiver comprising:
the display device according to claim 10; and
a receiving part which receives a television broadcast,
wherein
an image is displayed on the display device based on the television broadcast received at the receiving part.

23. A television receiver comprising:
the display device according to claim 11; and
a receiving part which receives a television broadcast,
wherein
an image is displayed on the display device based on the television broadcast received at the receiving part.

24. A television receiver comprising:
the display device according to claim 12; and
a receiving part which receives a television broadcast,
wherein
an image is displayed on the display device based on the television broadcast received at the receiving part.

25. A television receiver comprising:
the display device according to claim 15; and
a receiving part which receives a television broadcast,
wherein
an image is displayed on the display device based on the television broadcast received at the receiving part.

26. A television receiver comprising:
the display device according to claim 16; and
a receiving part which receives a television broadcast,
wherein
an image is displayed on the display device based on the television broadcast received at the receiving part.
